(19) United States
(12) Patent Application Publication
(10) Pub. No.: US 2009/0257660 A1
(43) Pub. Date: Oct. 15, 2009

(54) Shape determination of objects with surface matching

(75) Inventors: Stefan Hain, Effeltrich (DE); Hubert Mooshofer, Munchen (DE); Fabricio de Carvalho Ferreira, Munchen (DE)

Correspondence Address: King & Spalding LLP, 401 Congress Avenue, Suite 3200, Austin, TX, 78701, US

(73) Assignee: Siemens Aktiengesellschaft, Muenchen (DE)

(21) Appl. No.: 12/407,318

(22) Filed: Mar. 19, 2009

(30) Foreign Application Priority Data
Mar. 20, 2008 (DE) 10 2008 015 235.8
Jan. 19, 2009 (DE) 10 2009 005 111.2

(51) Int. Cl. G06K 9/46

(52) U.S. Cl. 382/204

(57) ABSTRACT

A method for inspecting component surfaces by a scanning test system, with the activation of the test system taking place such that, based on a known region of the component surface, an estimation of the component shape is performed, the estimation at the edge of the known region is drawn up at least for one part of the edge, this estimation is used for the calculation of the path for the scanning system, the inspection during scanning is implemented along this path and the deviation from the true component shape is measured so that the exact shape of the component is known along this path.

### CROSS-REFERENCE TO RELATED APPLICATIONS

This application claims priority to German patent application No. 10 2008 015 235.8, filed Mar. 20, 2008 and German patent application No. 10 2009 005 111.2, filed Jan. 19, 2009. The complete disclosure of the above-identified priority applications is hereby fully incorporated herein by reference.

### TECHNICAL FIELD

The invention relates to a method for inspecting component surfaces by means of a scanning test system.

### BACKGROUND

With the non-destructive testing of a component, in the case of a scanning method, a probe has to be moved along the component surface, for instance for ultrasound or eddy current testing, in order to be able to test the points to be tested at the correct distance and angle, so that the surface to be tested is completely covered.

With certain manufacturing methods, for instance sintering or forming by bending or as a result of abrasive wear on components which were already in use, individual different shape deviations appear. If the shape deviations are not taken into account during the scanning test, reliable inspection of the components by means of a scanning method is no longer possible with sufficient accuracy.

As a result of the individual nature of shape deviations, a shape measurement of the components is necessary.

One previous solution consists in determining the shape prior to the testing using a separate measuring system, for instance by a sheet-of-light imaging method with an optical system.

In a further step, reference points must ensure that the measured shape can be assigned to the positioning of the scanning system in respect of the position and the orientation. The disadvantage with this procedure is that the additional steps take time, i.e. reduce the throughput of the test system and that a relatively large additional outlay is necessary for a separate shape measuring system.

In the case of ultrasound immersion testing, optical shape measurement is also only feasible outside the dip tank.

It is also known to measure the component shape with the same scanning system, mechanism and sensor system with which the inspection takes place. It is advantageous here that no expensive additional hardware is necessary. If additional sensors, which can be actuated by the same electronics system, are needed however, the material outlay increases. The disadvantage is the significant expenditure of time taken to measure the shape. The speed is generally determined by the operating speed of the scanning mechanism, so that approximately double the time outlay occurs overall.

There is the possibility of accurately measuring the deviation from the component surface during the scanning process and immediately using this information to control the scanning mechanism. To this end, an extremely rapid control loop consisting of surface measurement, measuring evaluation and motor control would be necessary however. The disadvantage here is that very minimal reaction times result in large positioning errors and thus in an unreliable inspection. Conventional motor controls are also designed to follow previously known paths.

### SUMMARY

According to various embodiments, the shape of a test sample can be measured using the same scanning system, mechanism and sensor system, saving almost all the time taken for additional scanning movements.

According to an embodiment, a method for inspecting component surfaces by means of a scanning test system may comprise the steps of:—activating the test system such that an estimation of the component shape is drawn up based on a known region of the component surface,—preparing the estimation at the edge of the known region at least for a part of the edge,—using the estimation to calculate a path for the scanning system,—implementing an inspection when scanning along the path, and—measuring a deviation from the true component shape so that the exact shape of the component is known along this path.

According to a further embodiment, both the inspection and also the determination of the component shape may take place using the same sensors. According to a further embodiment, with the inspection, a repetition of individual scanning lines may take place with a large deviation between the estimation and actual shape. According to a further embodiment, a dynamic selection of the shape model can be performed. According to a further embodiment, a known region may consist of several unrelated parts. According to a further embodiment, a known region, which has a rectangular shape, can be extended on one or two sides. According to a further embodiment, a linking of a test sample movement and component shape can be performed in the case of a cylindrical tube for instance. According to a further embodiment, an estimation of the component shape for the points next to be inspected may take place. According to a further embodiment, a smoothing of the estimated component shape may take place by means of low pass filtering. According to a further embodiment, a plausibility check of the estimated component shape may take place in order to test a curvature. According to a further embodiment, estimation may take place with a priori knowledge.

According to another embodiment, a handling system for inspecting component surfaces implementing a scanning test, may comprise a sensor for scanning across the component surfaces, wherein the handling system is operable to be activated such that a known subregion of the component surface is retraced, an estimation at the edge of the known region is performed at least for one part of the edge, this estimation for the calculation of a path being used for the scanning test and the inspection is implemented when scanning along this path.

According to a further embodiment, the system may be operable to detect a movement of the test sample during the inspection of a component surface. According to a further embodiment, the test sample may be a cylindrically rotating shaft.

### BRIEF DESCRIPTION OF THE DRAWINGS

Embodiments are described below with reference to schematic figures which do not restrict the invention.

FIG. 1 shows a schematic drawing of the regions of the known/estimated shape (with a meander scan),

FIG. 2 shows a schematic drawing of the regions of a known/estimated shape (with a spiral scan),

FIG. 3 shows a schematic drawing of the regions of a known/estimated shape (when scanning the surface of a cylindrical tube)

FIG. 4 shows a combination of test sample movements and component shape with a cylindrical tube,

FIG. 5 shows a plane model for the local estimation of the component shape,

FIG. 6 reproduces an illustration of the repetition of individual scanning lines, with a large deviation 5.

### DETAILED DESCRIPTION

According to various embodiments, an estimation of the component shape is used instead of the actual component shape in order to control the scanning system.

The estimation is to be drawn up sufficiently closely to the true shape so that the inspection can be implemented with the required accuracy. It is advantageous if the complete component shape or an estimation of the complete component shape is not needed at the start of the inspection. It is instead sufficient to estimate the component shape before tracing a scanning curve within the region of this scanning curve.

Based on a known region, the method creates an estimation for the component shape at the edge of the known region and/or at least for a part of the edge of the known region. The path is then calculated for the scanning mechanism using this estimation. During the scanning process along this path, the inspection is implemented and the deviation from the true component shape is measured at the same time so that the exact shape of the component is then also known exclusively along this path.

For a small region of the component surface, it is thus only necessary at the start of an inspection to determine the shape in advance using one or a few scanning lines for instance.

### Course of a Selected Estimation

The starting point is the knowledge of the true shape for a segment of the component,
A shape model can be used for estimation purposes:
   a global—,
   a partial—or
   a local shape model.

### Shape Models are for Instance

local shape models: for instance plane, cylinder or sphere segment etc.
global or partial shape model; describes the shape of the test sample overall, and/or in large segments.
if the overall region is observed, i.e. the form of the test sample, the model thus depends on the test sample. As all possible types of deformations are taken into account in order to create a global shape model, a local shape model is generally easier to manage.
a possible use of a global shape model exists with significantly curved points on the component.
adjusting the shape model to the known parts of the true shape.
calculating the parameters of the shape model so that the shape model and the true shape are aligned as much as possible.
determining the parameters by means of regression:
   with a global shape model for the overall test sample;
   with a partial shape model one after the other for the regions of the test sample in each instance,
   with a local shape model one after the other for each point in the vicinity which is the next to be inspected.
estimating the component shape for the points which are next to be inspected:
a smoothing of the estimated component shape can also take place by means of low pass filtering,
a plausibility check of the estimated component shape can also take place, to test a curvature for instance; compare with a priori knowledge
calculate the scanning path with the aid of the surface shape
smooth the scanning path by means of low pass filtering for instance
a plausibility check of the scanning path, for instance the control of the curvature, comparison with a priori knowledge, can also take place.

### The Following Advantages are Achieved by Various Embodiments

No shape measurement of the complete test region on a component is needed in advance.
No hardware outlay is incurred for an additional shape measuring system.
Apart from the starting region, no additional scanning movements are needed for shape measurement purposes.
An increase in the inspection throughput can be achieved, as a result of which the testing costs reduce per component.
The path is known prior to the actual retracing process.
Field of use: with standard motor controls.

### Possible Variations

Use of the same sensors for inspection on the one hand and determination of the component shape on the other hand.
Testing and if necessary repetition of individual scanning lines, in the case of a large deviation between estimation and actual shape.
Dynamic selection of the shape model.
The known region can consist of several unrelated parts.
If the known region is a rectangle, a one-sided or two-sided extension is possible.
Combination of test sample movement and component shape, for instance in the case of a cylindrical tube.

The starting point is the knowledge of the true shape for a segmented component. A global, partial or local shape model can be used for estimation purposes, for instance a plane, cylinder or sphere segment.

A global and/or a partial shape model describes the shape of the test sample overall, and/or in large regions, i.e. the design of the model depends on the test sample. As many types of deformations are considered in order to create a global shape model, a local shape model is generally easier to manage.

One possible use of a global shape model exists in respect of controlling the curvature, by comparison with a priori knowledge.

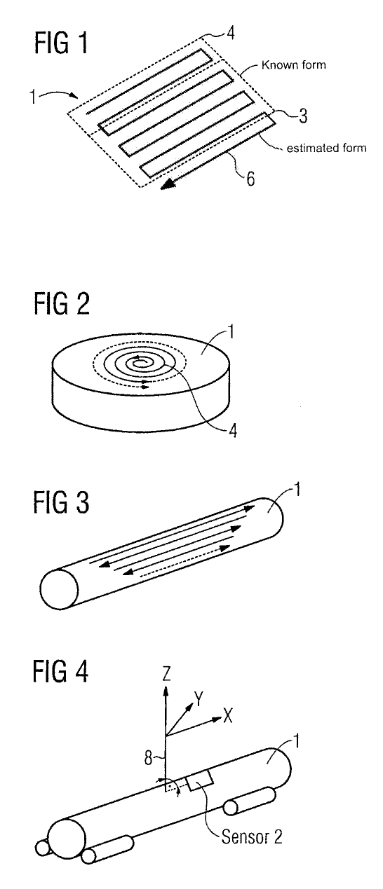

FIG. 1 represents a drawing with a flat shape model. At the start of the path 6 a part of the shape of this surface is known on the component surface 1. This was measured with a separate test system for instance.

Based on this known region 4, estimations and corrections are already plotted in FIG. 1 for the next segment of the path in each instance. Estimated values, for instance interpretation values, are assumed at an edge 3 of the known region 4 for a path to be determined. This estimation allows the calculation of a path 6 to be precalculated for the scanning system. The inspection along the curve 6 is implemented using this data and the deviation from the true component shape is measured. In FIG. 1, the edge 3 between the known region 4 and the outlying region is characterized for the estimation and interpretation. The estimated shape of the path 6 thus lies, as shown, outside the known region 4.

FIG. 2 shows the system comprising a known, estimated, corrected and once again estimated region on a spiral-shaped scanning of a workpiece surface 1. If the spiral-shaped path extends from the inside outwards, the inner regions of the path are separately measured for instance and represent a known region 4. The closest regions to the outside are firstly estimated in each instance and a path is then precalculated and this path is then retraced, at the same time as the inspection of the tool surface, with deviations from the true component shape being measured such that the exact shape of the component can be determined along this path.

FIG. 3 shows a schematic drawing of the regions of a known and/or estimated shape in the case of a testing process on the surface of a cylindrical tube.

FIG. 5 shows a combination which also takes a movement of the test sample into account in addition to determining data on the surface of a cylindrical tube. A cylindrical body or shaft is rotated on the bearing and at the same time on the transmission, shown by bearing rollers for a shaft. If the path of the surface is not ideally formed, the shape of the path is produced by the shape in the longitudinal direction with the addition of the center point movement. A center point movement will then occur in each instance if the non-ideal circular shape of the shaft leads thereto.

FIG. 5 records in a known region 4 true supporting points which are guaranteed in a known region 4. The edge 3 of this known region 4 again represents the limit of reliably determined data. External supporting points relate to estimated values, with a shape model 7 being shown in FIG. 5, which is in particular a flat shape model.

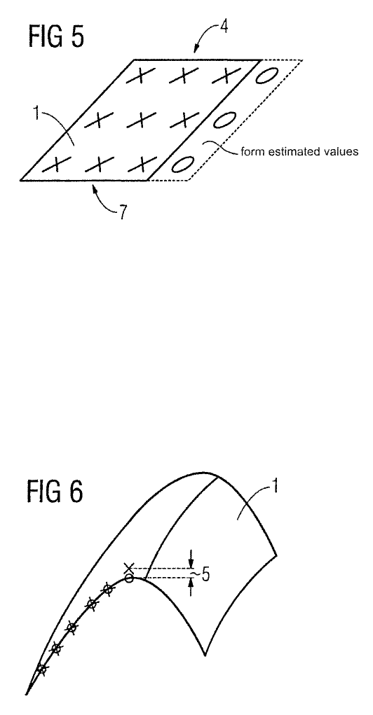

FIG. 6 indicates the repetition of individual scanning lines. Such a repetition is necessary if an excessively large deviation 5 occurs between the estimated value and/or supporting points and true value.

What is claimed is:

1. A method for inspecting component surfaces by means of a scanning test system, the method comprising the steps of:
activating the test system such that an estimation of the component shape is drawn up based on a known region of the component surface,
preparing the estimation at the edge of the known region at least for a part of the edge,
using the estimation to calculate a path for the scanning system,
implementing an inspection when scanning along the path, and
measuring a deviation from the true component shape so that the exact shape of the component is known along this path.

2. The method according to claim 1, wherein both the inspection and also the determination of the component shape take place using the same sensors.

3. The method according to claim 1, wherein with the inspection, a repetition of individual scanning lines takes place with a large deviation between the estimation and actual shape.

4. The method according to claim 1, wherein a dynamic selection of the shape model is performed.

5. The method according to claim 1, wherein a known region consists of several unrelated parts.

6. The method according to claim 1, wherein a known region, which has a rectangular shape, can be extended on one or two sides.

7. The method according to claim 1, wherein a linking of a test sample movement and component shape is performed in the case of a cylindrical tube for instance.

8. The method according to claim 1, wherein an estimation of the component shape for the points next to be inspected takes place.

9. The method according to claim 1, wherein a smoothing of the estimated component shape takes place by means of low pass filtering.

10. The method according to claim 1, wherein a plausibility check of the estimated component shape takes place in order to test a curvature.

11. The method according to claim 1, wherein estimation takes place with a priori knowledge.

12. A handling system for inspecting component surfaces implementing a scanning test, comprising a sensor for scanning across the component surfaces, wherein the handling system is operable to be activated such that a known subregion of the component surface is retraced, an estimation at the edge of the known region is performed at least for one part of the edge, this estimation for the calculation of a path being used for the scanning test and the inspection is implemented when scanning along this path.

13. The system as claimed in claim 12, wherein the system is operable to detect a movement of the test sample during the inspection of a component surface.

14. The system as claimed in claim 13, wherein the test sample is a cylindrically rotating shaft.

15. A scanning test system for inspecting component surfaces, comprising:
means for activating the test system such that an estimation of the component shape is drawn up based on a known region of the component surface,
means for preparing the estimation at the edge of the known region at least for a part of the edge,
means for using the estimation to calculate a path for the scanning system,
means for implementing an inspection when scanning along the path, and
means for measuring a deviation from the true component shape so that the exact shape of the component is known along this path.

16. The system according to claim 15, comprising a sensor operable to be used for both the inspection and also the determination of the component shape.

17. The system according to claim 15, wherein the system is operable to perform a dynamic selection of the shape model.

18. The system according to claim 15, wherein a known region consists of several unrelated parts.

19. The system according to claim 15, wherein a known region, which has a rectangular shape, can be extended on one or two sides.

20. The system according to claim 1, wherein the system is operable to perform a linking of a test sample movement and component shape in the case of a cylindrical tube for instance.
